(19) United States
(12) Patent Application Publication
(10) Pub. No.: US 2014/0063841 A1
(43) Pub. Date: Mar. 6, 2014

(54) FRONT LIGHT MODULE

(71) Applicant: Heng-Sheng KUO, New Taipei City (TW)

(72) Inventor: Heng-Sheng KUO, New Taipei City (TW)

(21) Appl. No.: 13/596,426

(22) Filed: Aug. 28, 2012

(51) Int. Cl. F21V 8/00

(52) U.S. Cl. 362/603

(57) ABSTRACT

A front light module is installed in front of a panel, and the front light module includes a light source, a light guide plate and an intermediate layer disposed on an external side of the panel, and the light guide plate is provided for receiving a light emitted from the light source and reflecting and refracting the light onto the panel, and the light guide plate has a plurality of microstructures disposed on at least one side parallel to the panel, and the intermediate layer is filled and distributed in the microstructures, so as to avoid glare and enhance the brightness and uniformity of the panel.

### FIELD OF THE INVENTION

The present invention relates to a light source module, in particular to a front light module.

### BACKGROUND OF THE INVENTION

In general, most display panels require a light source module for providing sufficient brightness and distributing a light source uniformly, so as to achieve a uniform, high-brightness and wide-angle display effect. If the light source module is installed at a position in front of a glass display device, the light source module is called a front light module.

The front light module is a product that converts a point or line light source into a plane light source with uniform brightness by a light guide structure. In daytime or an environment with sufficient illuminations, the front light module can use an external light source to provide a uniform brightness. In an environment with insufficient external light sources, the front light module immediately turns on its light source to maintain a normal display of images from the panel. Therefore, any display panel adopting the front light module can save electric power significantly and can be applied in a portable information device such as a personal digital assistant, a smartphone, and an e-book reader.

However, glare, insufficient brightness, or non-uniform light often occurs during the use of the conventional front light module. In addition, the light guide plate of the front light module may have a plurality of microstructures formed thereon, so that the microstructures can distribute the light source to produce a plane light source with uniform brightness. However, users still can vaguely see the existence of the marks of the microstructures, which will reduce the comfortability of the use. This is a main objective of the present invention to overcome such problem.

In view of the aforementioned problem, the inventor of the present invention based on years of experience in the related industry to conduct extensive researches and experiments, and finally provided a feasible design in accordance with the present invention to overcome the problems of the prior art.

### SUMMARY OF THE INVENTION

Therefore, it is a primary objective of the present invention to provide a front light module to avoid glare and enhance the brightness and uniformity of the panel.

To achieve the foregoing objective, the present invention provides a front light module installed in front of a panel, and the panel has a viewing area, and the front light module comprises a light source, a light guide plate and an intermediate layer, wherein the light guide plate is installed on an external side of the panel, and the light guide plate is provided for receiving a light emitted from the light source and reflecting and refracting the light onto the panel, and the light guide plate has a plurality of microstructures disposed on at least one side parallel to the panel, and the intermediate layer is filled and distributed in the microstructures.

Another objective of the present invention is to provide a front light module, wherein the light guide plate has a plurality of microstructures disposed on a side parallel to the intermediate layer. With the installation of the front light module of the present invention, vaguely seen marks of the microstructures can be avoided to enhance the comfortability of the use.

Compared with the prior art, an intermediate layer is filled and distributed in the microstructures of the light guide plate of the front light module of the present invention. Since the intermediate layer is made of water, colloid or silicone, therefore better refraction and light guide effect can be achieved when the light passes through the intermediate layer, and the light can be uniformly and wholly reflected and refracted to the panel to provide sufficient brightness, enhance the uniformity and brightness of the panel, and improve the applicability of the present invention.

### BRIEF DESCRIPTION OF THE DRAWINGS

FIG. 1 is a cross-sectional view of a front light module in accordance with a first preferred embodiment of the present invention;

FIG. 2 is a cross-sectional view of a front light module in accordance with a second preferred embodiment of the present invention; and

FIG. 3 is a cross-sectional view of a front light module in accordance with a third preferred embodiment of the present invention.

### DESCRIPTION OF THE PREFERRED EMBODIMENTS

The technical contents of the present invention will become apparent with the detailed description of preferred embodiments accompanied with the illustration of related drawings as follows. It is noteworthy that the drawings are provided for the purpose of illustrating the present invention, but not intended for limiting the scope of the invention.

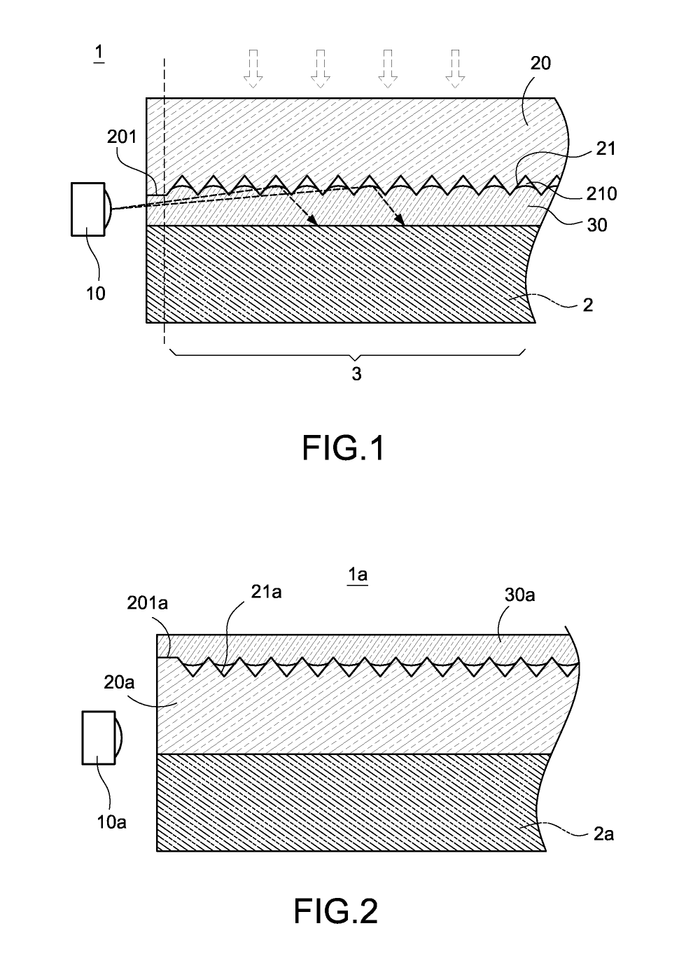

With reference to FIG. 1 for a cross-sectional view of a front light module of the present invention, the front light module 1 is installed in front of a panel 2, and the panel 2 has a viewing area 3. The front light module 1 comprises a light source 10, a light guide plate 20, and an intermediate layer 30, wherein the light source 10 is disposed on a side of the light guide plate 20 and the intermediate layer 30.

The light source 10 is an optical diode including but not limited to a light emitting diode (LED) or a laser diode (LD), and the light source 10 is can be a light source of a cold cathode tube.

The light guide plate 20 is made of an optically non-absorbent material with a high reflective rate, and the light guide plate 20 is installed on an external side of the panel 2. The light guide plate 20 receives a light emitted from the light source 10 and reflects and refracts the light onto the panel 2, and the light guide plate 20 has a plurality of microstructures 21 on at least one side 201 parallel to the panel 2.

The intermediate layer 30 is in a liquid state or in a colloidal form or is formed by solidifying a colloid, and the intermediate layer 30 is transparent to allow users to view a displayed image or text clearly. The intermediate layer 30 is made of water, colloid, or silicone. With the installation of the intermediate layer 30, better refraction and light guide effects can be achieved when the light passes through the intermediate layer 30, so as to enhance the uniformity and brightness of the light of the front light module 1.

Preferably, the intermediate layer 30 is filled and distributed in the microstructures 21 in a viewing area 3 of the light guide plate 20. In FIG. 1, a side of the intermediate layer 30 is attached to the light guide plate 20 directly, and the other side of the intermediate layer 30 is attached to the panel 2.

In a preferred embodiment of the present invention, the light guide plate 20 has a plurality of microstructures 21 disposed on a side parallel to the panel 2. However, the microstructures 21 are not limited to any particular shape, and they can be a plurality of grooves, V-shaped grooves or serrated grooves.

The intermediate layer 30 is filled in the microstructures 21. More specifically, each of the microstructures 21 has a reflection space 210, and the intermediate layer 30 is filled and distributed in some of the reflection spaces 210 only.

In this preferred embodiment, the light guide plate 20 has a plurality of microstructures 21 disposed on the side 201 proximate to the panel 2. The invention is not limited to such arrangement only, but the microstructures 21 can be installed on a side away from the panel 2, or the microstructures 21 are installed on both opposite sides of the light guide plate 20 and parallel to the panel 2.

It is noteworthy that when external light is sufficient, the external light can be passed through the light guide plate 20 and projected onto the panel 2 to provide sufficient brightness to the panel 2 without turning on the light source 10.

With reference to FIG. 2 for a cross-sectional view of a front light module in accordance with the second preferred embodiment of the present invention, this preferred embodiment is substantially the same as the previous preferred embodiment, and the front light module 1a comprises a light source 10a, a light guide plate 20a, and an intermediate layer 30a, and the light guide plate 20a has a plurality of microstructures 21a. The light source 10a is disposed on a side of the light guide plate 20a and the intermediate layer 30a, and the intermediate layer 30a is filled and distributed in the microstructures 21a.

The difference between this preferred embodiment and the previous preferred embodiment resides on that the microstructures 21a of the light guide plate 20a are installed on a side 201a away from the panel 2a. In other words, a side of the light guide plate 20a is attached to the intermediate layer 30a, and the other side of the light guide plate 20a is attached to the panel 2a.

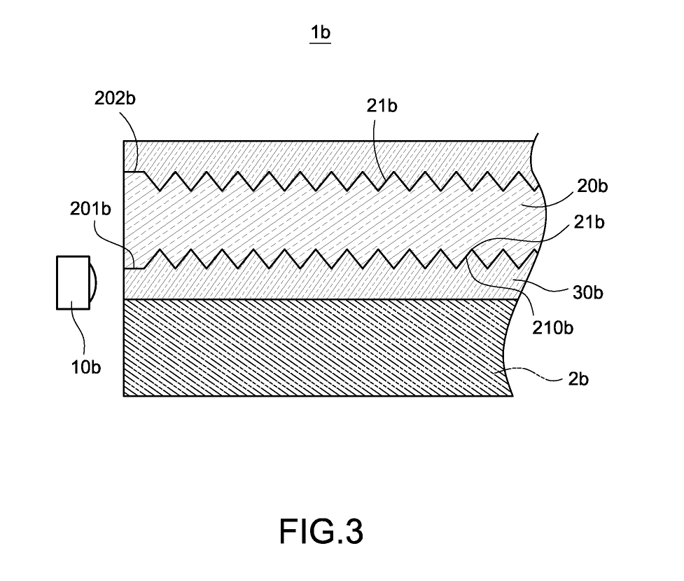

With reference to FIG. 3 for a cross-sectional view of a front light module in accordance with the third preferred embodiment of the present invention, the front light module 1b of this preferred embodiment comprises a light source 10b, a light guide plate 20b, and an intermediate layer 30b.

The difference between this preferred embodiment and the first preferred embodiment resides on that the light guide plate 20b has a plurality of microstructures 21b disposed on two opposite sides 201b, 202b parallel to the panel 2b respectively (such as attaching onto a side 201b of the panel 2a directly and the other side 202b away from the panel 2b). The other difference is that the intermediate layer 30b is filled up in the reflection space 210b of the microstructures 21b.

It is noteworthy that the front light module 1, 1a, 1b of the present invention is integrated into a portable information device (not shown in the figure), so that the front light module 1, 1a, 1b can be used as the light source module of the portable information device to reduce glare and enhance the brightness and uniformity of the portable information device.

While the invention has been described by means of specific embodiments, numerous modifications and variations could be made thereto by those skilled in the art without departing from the scope and spirit of the invention set forth in the claims.

What is claimed is:

1. A front light module, installed in front of a panel, and the panel having a viewing area, and the front light module comprising:
a light source;
a light guide plate, installed on an external side of the panel, for receiving a light emitted from the light source, and reflecting and refracting the light onto the panel, and the light guide plate having a plurality of microstructures disposed on at least one side parallel to the panel; and
an intermediate layer, filled and distributed in the microstructures.

2. The front light module of claim 1, wherein the light source is disposed on a side of the light guide plate.

3. The front light module of claim 1, wherein the light guide plate includes a plurality of microstructures disposed on a side of the light guide plate proximate to the panel.

4. The front light module of claim 3, wherein the intermediate layer has a side attached to the light guide plate and the other side attached to the panel.

5. The front light module of claim 3, wherein the light guide plate includes a plurality of microstructures disposed on a side away from the panel.

6. The front light module of claim 5, wherein the light guide plate has a side attached to the intermediate layer and the other side attached to the panel.

7. The front light module of claim 1, wherein the intermediate layer is filled and distributed in the microstructures in a viewing area of the light guide plate.

8. The front light module of claim 1, wherein each of the microstructures has a reflection space, and the intermediate layer is filled and distributed in the reflection space.

9. The front light module of claim 1, wherein each of the microstructures has a reflection space, and the intermediate layer is filled up in the reflection space.

10. The front light module of claim 1, wherein the intermediate layer is in a liquid form.

11. The front light module of claim 10, wherein the intermediate layer is comprised of water or a colloid.

12. The front light module of claim 1, wherein the intermediate layer is in a colloidal form.

13. The front light module of claim 12, wherein the intermediate layer is comprised of a colloid.

14. The front light module of claim 1, wherein the intermediate layer is formed by solidifying a colloid.

15. The front light module of claim 1, wherein the intermediate layer is transparent.
